(19) United States
(12) Patent Application Publication
(10) Pub. No.: US 2023/0089730 A1
(43) Pub. Date: Mar. 23, 2023

(54) SHORT MESSAGE SERVICE ENCRYPTION SECURE FRONT-END GATEWAY

(71) Applicant: AT&T Mobility II LLC, Atlanta, GA (US)

(72) Inventor: Arturo Maria, Bellevue, WA (US)

(21) Appl. No.: 17/482,576

(22) Filed: Sep. 23, 2021

(51) Int. Cl. H04W 12/08; H04W 12/0431

(52) U.S. Cl. CPC H04W 12/08; H04W 12/0431

(57) ABSTRACT

A system in which SMS messages may be encrypted end-to-end. A method may include receiving a first unique key (UK), wherein the unique key is from a short message service (SMS) encryption function; receiving an encrypted SMS message, wherein the encrypted SMS message in which the destination is for an application of an enterprise system, wherein the SMS message comprises a header with a second UK; determining that the first UK matches the second UK; based on the first UK matching the second UK: authorizing decryption of the encrypted SMS message, and providing instructions to send the decrypted SMS message to the application of the enterprise system.

### BACKGROUND

An external short messaging entity (ESME) is an external application that connects to a short message service center (SMSC) to engage in the sending or receiving of short message service (SMS) messages. Typical examples of ESMEs are systems that send automated marketing messages to mobile users and voting systems that process SMS votes.

This background information is provided to reveal information believed by the applicant to be of possible relevance. No admission is necessarily intended, nor should be construed, that any of the preceding information constitutes prior art.

### SUMMARY

A system is described whereby SMS messages may be encrypted end-to-end. In an example, an apparatus may include a processor and a memory coupled with the processor that effectuates operations. The operations may include receiving a first unique key (UK), wherein the first UK is from a short message service (SMS) encryption function; receiving an encrypted SMS message, wherein the encrypted SMS message in which the destination is for an application of an enterprise system, wherein the SMS message comprises a header with a second UK; determining that the first UK matches the second UK; based on the first UK matching the second UK: authorizing decryption of the encrypted SMS message, and providing instructions to send the decrypted SMS message to the application of the enterprise system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system that uses short message service (SMS).

FIG. 2 illustrates an exemplary system that uses SMS.

FIG. 3 illustrates an exemplary system that uses SMS.

FIG. 4 illustrates an exemplary system for implementing a short message service encryption secure front-end gateway.

FIG. 5 illustrates an exemplary method for implementing a short message service encryption secure front-end gateway.

FIG. 6 illustrates an exemplary method for implementing a short message service encryption secure front-end gateway.

FIG. 7 illustrates a schematic of an exemplary network device.

FIG. 8 illustrates an exemplary communication system that provides wireless telecommunication services over wireless communication networks.

### DETAILED DESCRIPTION

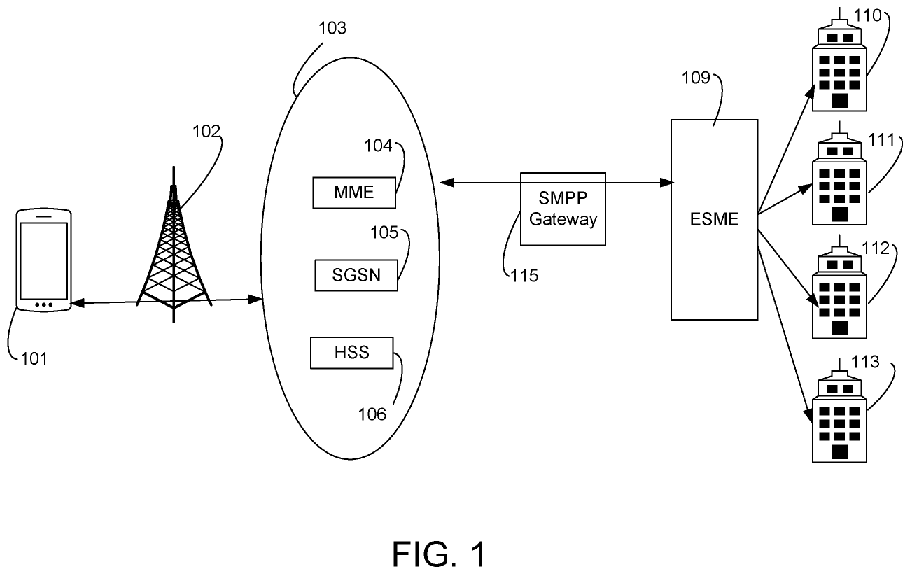

FIG. 1 illustrates an exemplary system that uses short message service (SMS). User equipment (UE) 101 may be communicatively connected with enterprise system 110, enterprise system 111, enterprise system 112, enterprise system 113 via base station 102, mobile carrier core network 103, short message peer-to-peer (SMPP) gateway 115, or external short messaging entity (ESME) 109. Mobile carrier core network 103 may include mobility management entity (MME) 104, serving general packet radio service (GPRS) support node (SGSN) 105, or home subscriber server (HSS) 106.

With continued reference to FIG. 1, UE 101 may transmit SMS messaging traffic. UE 101 communicates through the 4G (e.g., LTE) mobile carrier core network and may use network elements, such as MME 104, SGSN 105, and HSS 106. SMS traffic may travel from UE 101 to MME 104, SGSN 105, and SMPP gateway 115. SMPP gateway 115 may forward the message to the external entity, ESME 109. ESME 109 is usually owned by an aggregator (different from the wireless service provider). A wireless service provider, using SMPP gateway 115, interfaces with ESME 109 (an aggregator's device). ESME 109 usually receives traffic based on a short code. In an example scenario, an enterprise that uses enterprise system 110 may desire that the users (e.g., UE 101) send text to a short code in order to interact with enterprise system 110. Enterprise companies may contract with an aggregator company that controls ESME 109 in order to route the SMS traffic to enterprise system 110 based on the short code.

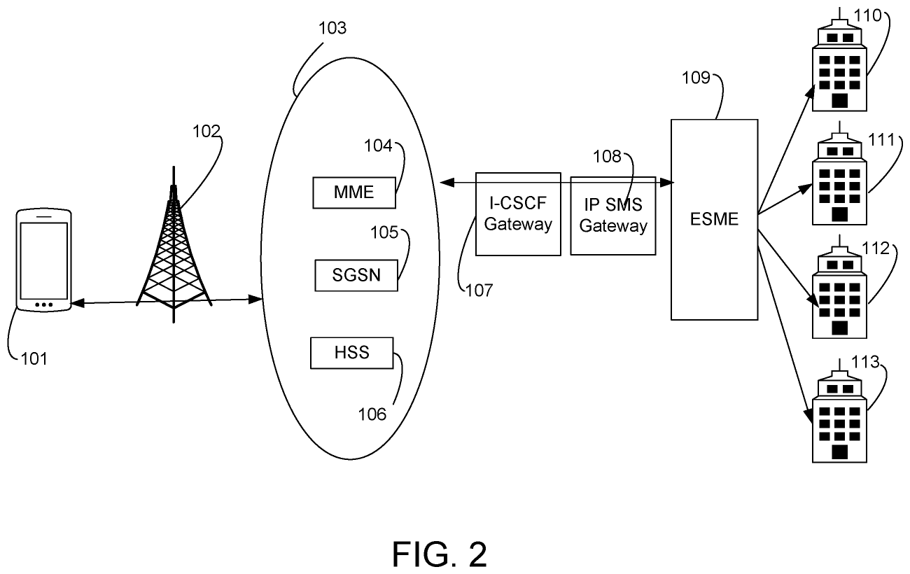

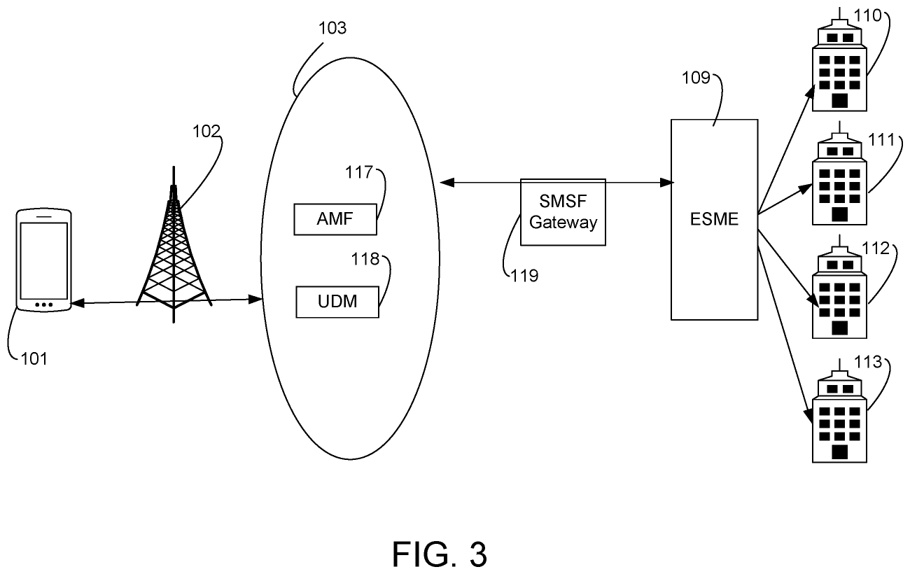

FIG. 2 illustrates an exemplary system that uses SMS in the context of LTE and IMS. The system of FIG. 2 is similar to the system of FIG. 1, except the SMS message is not carried in the control channel. Here, the SMS message may be carried in an internet protocol (IP) message. In LTE with IMS, the SMS may travel through network elements interrogating call session control function (I-CSCF) gateway 107 and an IP SMS gateway 108. The aforementioned elements may connect with ESME 109, which appropriately distributes the SMS traffic. FIG. 3 illustrates an exemplary system that uses SMS in the context of a 5G (or new radio—NR) architecture. In 5G, the SMS message may follow a similar path as LTE, except the core network elements are different (e.g., the core network includes access management function (AMF) 117 or unified data manager (UDM) 118) and the use of a SMS function (SMSF) gateway 119.

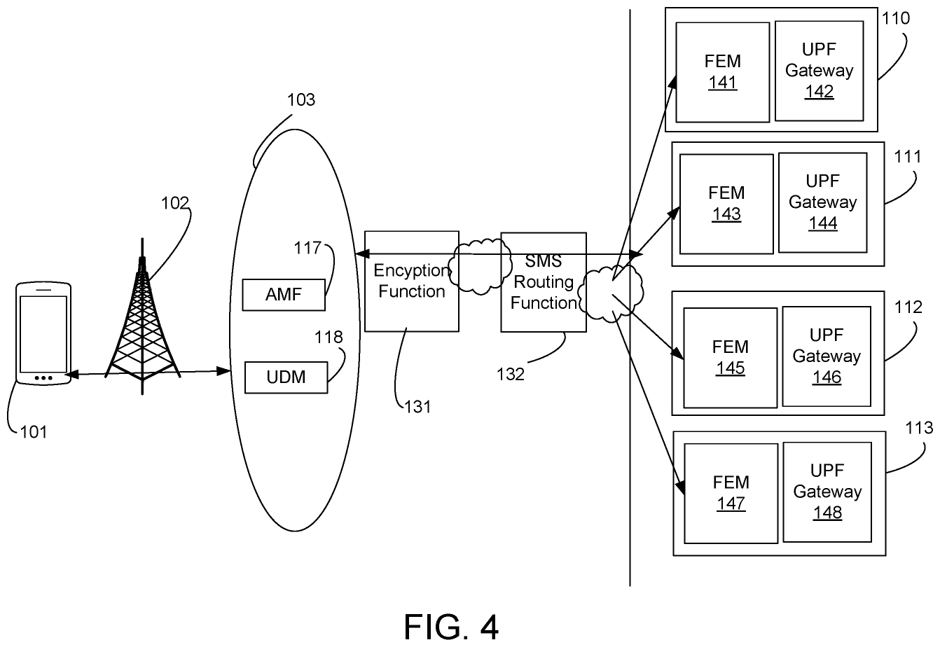

FIG. 4 illustrates an exemplary system for implementing a short message service encryption. UE 101 may be communicatively connected with enterprise system 110 (front end module (FEM) 141 and user plane function (UPF) gateway 142), enterprise system 111 (FEM 143 and UPF gateway 144), enterprise system 112 (FEM 145 and UPF gateway 146), or enterprise system 113 (FEM 147 and UPF gateway 148) via base station 102, mobile carrier core network 103, new encryption function (EF)131, and new SMS routing function 132. SMS routing function 132 may route SMS traffic to appropriate devices associated with different enterprises and may be a control plan session management function (SMF). In this architecture, ESME 109 is not needed. In 5G, there is a control plane and user plane. Enterprise system 110 uses UPF gateway 142.

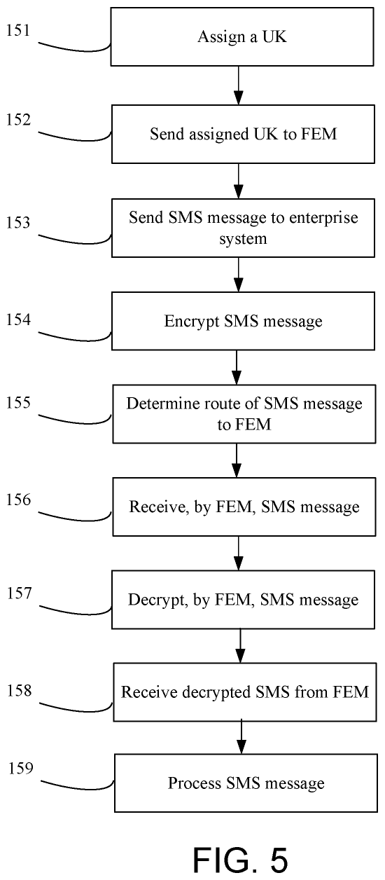

FIG. 5 illustrates an exemplary method for implementing a short message service encryption secure front-end gateway. The disclosed system may encrypt and secure SMS messages. At step 151, UE 101 may be assigned a unique key (UK) by encryption function (EF) 131. EF 131 may operate as a front end to SMS routing function 132 or as a standalone gateway. The UK may be determined using an algorithm, such as AES-256. The UK may be generated using a subscriber identity module (SIM) key or other UE identifier. The generated UK may be assigned to a unique UE, such as UE 101.

At step 152, EF 131 may communicate with FEM 141. FEM 141 may be a module of UPF gateway 142. EF 131 may send the assigned UK of step 151 to FEM 141 for encryption or decryption of messages from UE 101 or to UE 101. FEM 141 may have a table which associates UKs with specific applications within enterprise system 110 as well as UKs for each UE 101.

At step 153, UE 101 sends a SMS message with a destination address of a specific enterprise system (e.g., enterprise system 110), by using a code or by using an enterprise name.

At step 154, the SMS message may be encrypted by EF 131 and routed through EF 131 to SMS routing function 132.

At step 155, SMS routing function 132 may determine which FEM to route to based on the destination address of step 153.

At step 156, FEM 141 may receive the SMS message of UE 101.

At step 157, FEM 141 may decrypt the SMS message of UE 101 based on the encryption information received from EF 131, such as a UK value (e.g., UK of step 152), UE identifiers, enterprise system 110 identifiers, or the like. The SMS message may be routed in accordance with the FEM table to UPF gateway 142.

At step 158, UPF gateway 142 receives the decrypted SMS message from FEM 141.

At step 159, UPF gateway 142 may send the decrypted SMS message to another device or application in enterprise system 110 for further processing.

The SMS message may be encrypted in the core mobility network and routed to the enterprise system in an encrypted mode. This may be particularly useful when the SMS message traverses the Internet in order to arrive at enterprise system 110.

Herein, it is contemplated that some or all of EF 101 may be located at the base station, within the carrier core network, or on UE 101. This method may help address security gaps, ensure that only authorized users can send encrypted SMS messages to a specific enterprise, and increase carrier control over SMS communicated offers (e.g., marketing products or services). There is no need for an ESME as conventionally implemented.

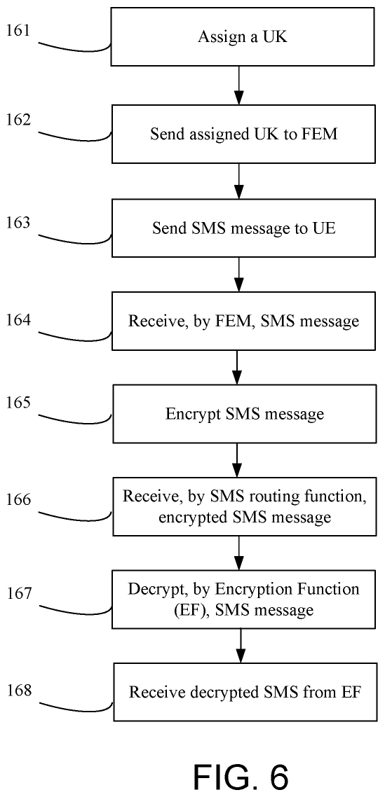

FIG. 6 illustrates an exemplary method for implementing a short message service encryption secure front-end gateway. The disclosed system may encrypt and secure SMS messages. At step 161, UE 101 (or a group of UEs) may be assigned a unique key (UK) by encryption function (EF) 131. EF 131 may reside as a front end to SMS routing function 132 or as a standalone gateway. The UK may be determined using an algorithm, such as AES-256. The UK may be generated using a subscriber identity module (SIM) key or other identifier. The generated UK may be assigned to a unique UE, such as UE 101.

At step 162, FEM 141 may receive the assigned UK, which may be for encryption or decryption of messages from UE 101, to UE 101, or a group of UEs. FEM 141 may have a table which associates UKs with specific applications within enterprise system 110 as well as UKs for UEs.

At step 163, an SMS message may be sent to UE 101 by an enterprise application (not shown) of enterprise system 110. The SMS message may have a header that includes an identifier for UE 101.

At step 164, FEM 141 may receive the SMS message (e.g., from UPF gateway 142).

At step 165, FEM 141 encrypts the SMS message using the UK.

At step 166, the encrypted SMS message is received by SMS routing function 132, in which SMS routing function 132 may route the SMS message to EF 131.

At step 167, EF 131 may decrypt and send the SMS message. As disclosed herein, EF 131 may store UK information or other information. The UK information or other information may help determine how a particular SMS message will be routed or may be used for encryption or decryption.

At step 168, UE 101 receives the SMS message.

It is contemplated that UE 101 may be associated with multiple UKs based on the number of gateways that UE 101 would be authorized to access. For example, UE 101 may be allowed to send SMS messages to multiple enterprise gateways residing at different locations. UKs would identify each unique user plane UPFs. Each time an SMS message is sent, the UK or set of UKs may be sent as part of the message. EF 131 would then be able to route the messages appropriately.

The disclosed subject matter generally would not, as of yet, be used for SMS mobile to mobile scenarios, but may be used for scenarios of SMS mobile to enterprise applications or enterprise devices, which would allow for very secure SMS messaging end-to-end.

The conventional SMS architecture has been in place for wireless carriers for decades. It generally does not allow the level of granularity and security that is preferred for new applications for SMS messaging. The disclosed system may allow for secure end-to-end SMS messaging to take place between authorized UEs and applications residing in enterprise gateways, which should allow wireless service providers to exercise greater control over messaging, improve security, and monetize these applications. The disclosed SMS encryption for each message may enable secure transmissions which are not present in conventional wireless networks. In a scenario, an SMS message may be encrypted in a core mobility network and routed to enterprise gateways in an encrypted mode. This feature allows SMS messages to traverse the Internet from a mobile edge or core to an enterprise system with the SMS message encrypted. The disclosed system allows for secure SMS messaging, additional monetization opportunities for 5G SMS offerings by a wireless provider, or increased enterprise control over SMS messaging.

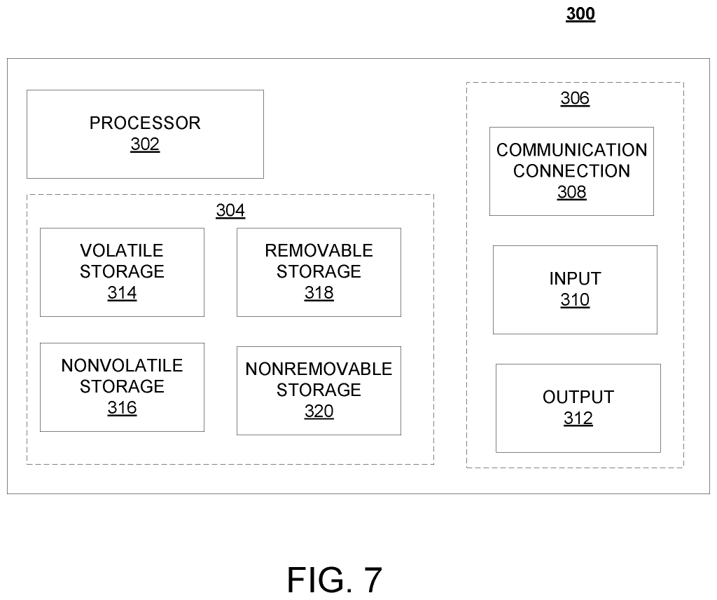

FIG. 7 is a block diagram of network device 300 that may be connected to or comprise a component of FIG. 1-FIG. 4. Network device 300 may comprise hardware or a combination of hardware and software. The functionality to facilitate telecommunications via a telecommunications network may reside in one or combination of network devices 300. Network device 300 depicted in FIG. 7 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 7 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 7) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

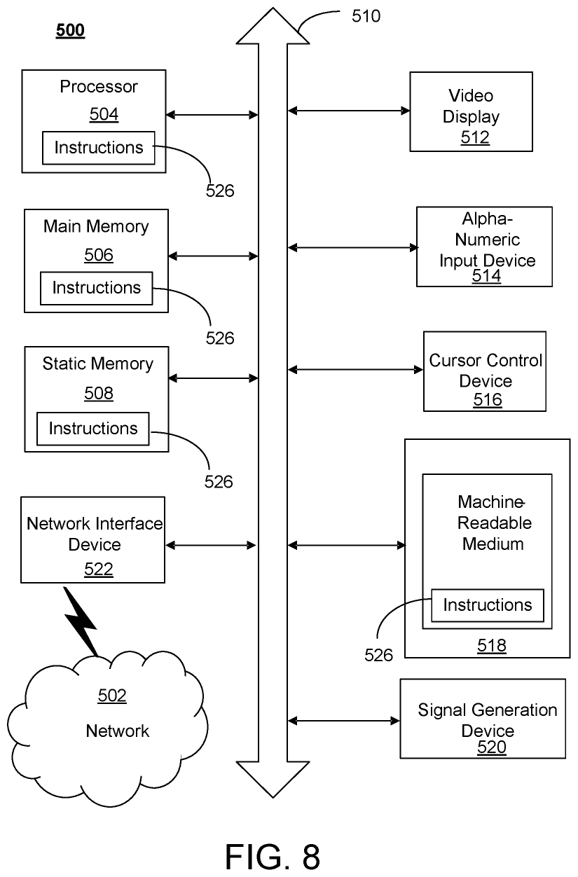

FIG. 8 depicts an exemplary diagrammatic representation of a machine in the form of a computer system 500 within which a set of instructions, when executed, may cause the machine to perform any one or more of the methods described above. One or more instances of the machine can operate, for example, as processor 302, UE 101, base station 102, UPF gateway 142, EF 141, AMF 117, UDM 118, and other devices of FIG. 1-FIG. 4. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which SMS encryption alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—SMS encryption and front-end gateways—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for a system for implementing a short message service encryption. In an example, an apparatus may include a processor and a memory coupled with the processor that effectuates operations. The operations may include receiving a first unique key (UK), wherein the first UK is from a short message service (SMS) encryption function; receiving an encrypted SMS message, wherein the encrypted SMS message in which the destination is for an application of an enterprise system, wherein the SMS message comprises a header with a second UK; determining that the first UK matches the second UK; based on the first UK matching the second UK: authorizing decryption of the encrypted SMS message, and providing instructions to send the decrypted SMS message to the application of the enterprise system. The apparatus may be an FEM. The first UK may be associated with a group of user equipment. The apparatus may receive an update of the mapping that maps the first UK to the first user equipment and a second user equipment, wherein the first user equipment and the second user equipment are different. All combinations in this paragraph (including the removal or addition of steps) are contemplated in a manner that is consistent with the other portions of the detailed description.

What is claimed:

1. A method comprising:
receiving a first unique key (UK), wherein the first UK is from a short message service (SMS) encryption function;
receiving an encrypted SMS message, wherein the encrypted SMS message destination is an application of an enterprise system, wherein the SMS message comprises a header with a second UK;
determining that the first UK matches the second UK;
based on the first UK matching the second UK:
authorizing decryption of the encrypted SMS message, and
providing instructions to send the decrypted SMS message to the application of the enterprise system.

2. The method of claim 1, further comprising decrypting the encrypted SMS message.

3. The method of claim 1, wherein the decryption of the encrypted SMS message uses the first UK.

4. The method of claim 1, wherein the first UK is associated with a user equipment.

5. The method of claim 1, wherein the first UK is associated with a group of user equipment.

6. The method of claim 1, further comprising:
mapping the first UK to a user equipment; and
receiving an update of the mapping of the first UK to the user equipment that maps the user equipment to a third UK, wherein the first UK and third UK are different.

7. The method of claim 1, further comprising:
mapping the first UK to a first user equipment; and
receiving an update of the mapping that maps the first UK to the first user equipment and a second user equipment, wherein the first user equipment and the second user equipment are different.

8. An apparatus comprising:
a processor; and
memory coupled with the processor, the memory storing executable instructions that when executed by the processor cause the processor to effectuate operations comprising:
receiving a first unique key (UK), wherein the first UK is from a short message service (SMS) encryption function;
receiving an encrypted SMS message, wherein the encrypted SMS message destination is an application of an enterprise system, wherein the SMS message comprises a header with a second UK;
determining that the first UK matches the second UK;
based on the first UK matching the second UK:
authorizing decryption of the encrypted SMS message, and
providing instructions to send the decrypted SMS message to the application of the enterprise system.

9. The apparatus of claim 8, the operations further comprising decrypting the encrypted SMS message.

10. The apparatus of claim 8, wherein the decryption of the encrypted SMS message uses the first UK.

11. The apparatus of claim 8, wherein the first UK is associated with a user equipment.

12. The apparatus of claim 8, wherein the first UK is associated with a group of user equipment.

13. The apparatus of claim 8, the operations further comprising:
mapping the first UK to a user equipment; and
receiving an update of the mapping of the first UK to the user equipment that maps the user equipment to a third UK, wherein the first UK and third UK are different.

14. The apparatus of claim 8, the operations further comprising:
mapping the first UK to a first user equipment; and
receiving an update of the mapping that maps the first UK to the first user equipment and a second user equipment, wherein the first user equipment and the second user equipment are different.

15. The apparatus of claim 8, wherein the apparatus is a virtual function associated with a user plane function gateway.

16. A computer readable storage medium storing computer executable instructions that when executed by a computing device cause said computing device to effectuate operations comprising:
receiving a first unique key (UK), wherein the first UK is from a short message service (SMS) encryption function;
receiving an encrypted SMS message, wherein the encrypted SMS message destination is an application of an enterprise system, wherein the SMS message comprises a header with a second UK;
determining that the first UK matches the second UK;
based on the first UK matching the second UK:
authorizing decryption of the encrypted SMS message, and
providing instructions to send the decrypted SMS message to the application of the enterprise system.

17. The computer readable storage medium of claim 16, the operations further comprising decrypting the encrypted SMS message.

18. The computer readable storage medium of claim 16, wherein the decryption of the encrypted SMS message uses the first UK.

19. The computer readable storage medium of claim 16, wherein the first UK is associated with a user equipment.

20. The computer readable storage medium of claim 16, wherein the first UK is associated with a group of user equipment.
